(19) United States
(12) Patent Application Publication
(10) Pub. No.: US 2019/0327954 A1
(43) Pub. Date: Oct. 31, 2019

(54) Pig Trap

(71) Applicant: Thomas H. Whitney, Fort Worth, TX (US)

(72) Inventor: Thomas H. Whitney, Fort Worth, TX (US)

(21) Appl. No.: 15/964,619

(22) Filed: Apr. 27, 2018

(51) Int. Cl. A01M 23/16

(52) U.S. Cl. CPC A01M 23/16

(57) ABSTRACT

An animal trap for holding animals may include the trap having an open bottom to allow access to the ground or support surface; the trap may have a frame to support a wire grid; a ground anchor to be positioned in the ground or support surface; and a flexible and extending connector to connect the frame with the ground anchor.

### FIELD OF THE INVENTION

The present invention relates to traps and more particularly to a trap without a floor.

### BACKGROUND

Traps are used to store animals to prevent them from escaping. Most traps includes a floor to provide a support surface for the animals and to prevent the animals from escaping the trap by borrowing the ground around the perimeter of the trap.

### SUMMARY

An animal trap for holding animals may include the trap may have an open bottom to allow access to the ground or support surface; the trap may have a frame to support a wire grid; a ground anchor to be positioned in the ground or support surface; and a flexible and extending connector to connect the frame with the ground anchor.

The frame may include a bottom frame member.

The frame may include a top frame member.

The frame may include a vertical frame member.

The flexible and extending connector may include a bungee cord.

The flexible and extending connector may include a spring.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of the housing/trap of the present invention;

FIG. 2 illustrates a portion of the housing/trap of the present invention;

FIG. 3 illustrates another embodiment of the housing/trap of the present invention;

FIG. 4 illustrates an embodiment of the housing/trap of the present invention;

FIG. 5 illustrates a portion of the housing/trap of the present invention;

FIG. 6 illustrates an embodiment of the housing class trap of the present invention;

FIG. 7 illustrates an embodiment of the housing/trap of the present invention

FIG. 8 illustrates multiple flexible and extending connectors of the present invention;

FIG. 9 illustrates a ground anchor of the present invention;

FIG. 10 illustrates a multitude of ground anchors of the present invention.

### DETAILED DESCRIPTION

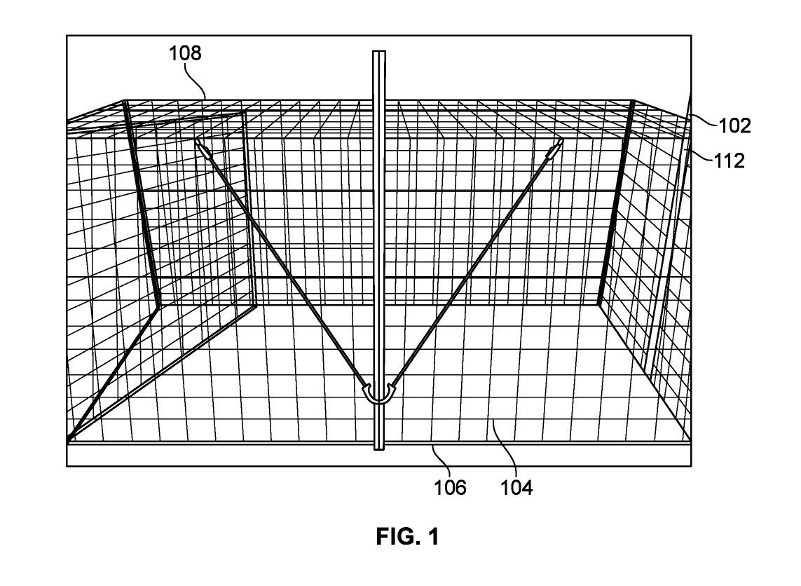

FIG. 1 illustrates a perspective view of the housing/trap 100 of the present invention and includes a frame 102 which may be connected to an array (grid) of wires 104 which may cover a front of the trap 100, the back of the trap 100, the sides of the trap 100 and the top of the trap 100 leaving the bottom of the trap 100 without the array of wires 104. Many animals such as pigs find a floor of any kind to be undesirable. These animals prefer to have their feet on the ground. However, the same animals can easily burrow under the sides of the trap 100 and escape from the trap 100.

The frame 102 as shown in FIG. 1 may include a a bottom frame member 106 and an opposing top frame member 108. Both the bottom frame member 106 and the top frame member 108 may be rectangular as shown in FIG. 1, oval, circular or any other shape. In addition, the frame 102 may include vertical frame members 110 which may extend from the bottom frame member 106 to the top frame member 108 to support the top frame member 108. In addition, the frame 102 may include a frame door 112 which may be connected to the vertical frame members 110 by hinges to allow the frame doors 112 to pivot to allow entry and exit from the trap 100. The frame 102 may be covered by an array of wires 104.

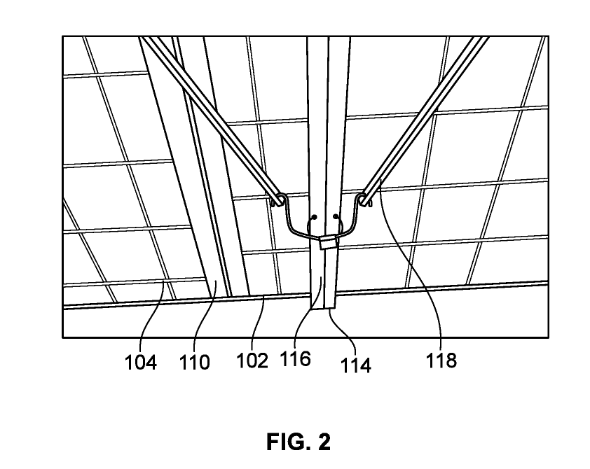

The frame 102 as shown in FIG. 2 may include a bottom frame member 106 and an opposing top frame member 108 (not shown in FIG. 2). Both the bottom frame member 106 and the top frame member 108 may be rectangular as shown in FIG. 2, oval, circular or any other shape. In addition, the frame 102 may include vertical frame members 110 which may extend from the bottom frame member 106 to the top frame member 108 to support the top frame member 108. In addition, the frame 102 may include a frame door 112 which may be connected to the vertical frame members 110 by hinges to allow the frame doors 112 to pivot to allow entry and exit from the trap 100. The frame 102 may be covered by an array of wires 104.

FIG. 2 illustrates a ground anchor 116 to anchor the trap 100 to the ground or support surface in order to prevent the animals from digging under the trap 100 and escaping. A flexible and extendable (and retractable) connector 118 may be attached to the ground anchor 116 and connected to the trap 100 more particularly to the frame 102. The flexible and extendable connector 118 keeps the trap 100 flush against the ground or support surface. If the animals should dig underneath the trap 100 the flexible and extendable connector 118 should maintain the contact between the trap 100 and the ground or support surface. The trap may be rectangular, circular, oval, triangular or a combination of the shapes or other appropriate shape.

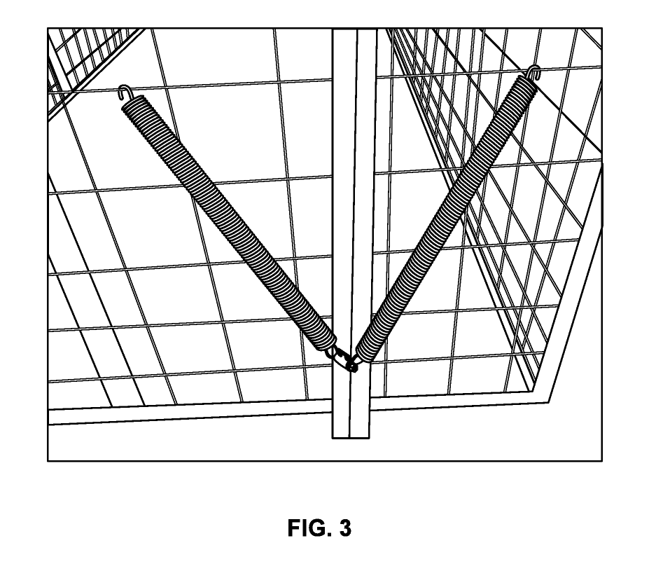

FIG. 3 illustrates an opposing pair of flexible and extendable connectors 118 which may be a pair of springs to connect the trap to the ground anchor 116. The springs may be sized to the size of the trap and other appropriate devices may be used for the flexible and extendable connectors.

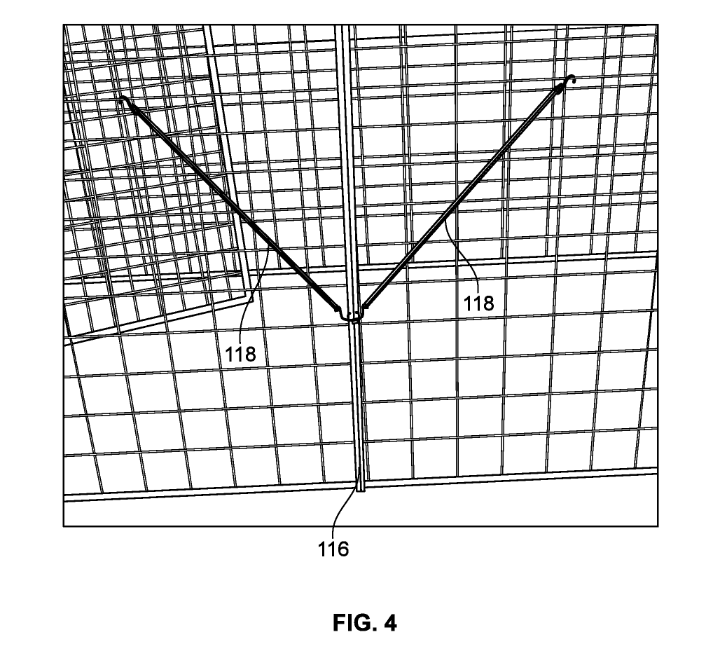

FIG. 4 illustrates another opposing pair of flexible and extendable connectors 118 which may be a pair of bungee cords (tie down cords) to connect the trap 100 to the ground anchor 116. The flexible and extendable connector 118 may connect to the trap 100 and may connect to the ground anchor 116.

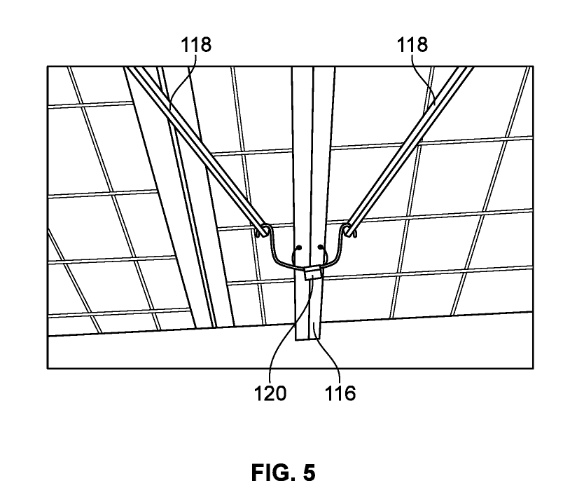

FIG. 5 illustrates a portion of the trap 100 and the opposing pair of flexible and extendable connectors 118 which may be a pair of bungee cords (tie down cords) to connect the trap 100 to the ground anchor 116 (by a suitable connector 120). The flexible and extendable connector 118 may connect to the trap 100 and may connect to the ground anchor 116.

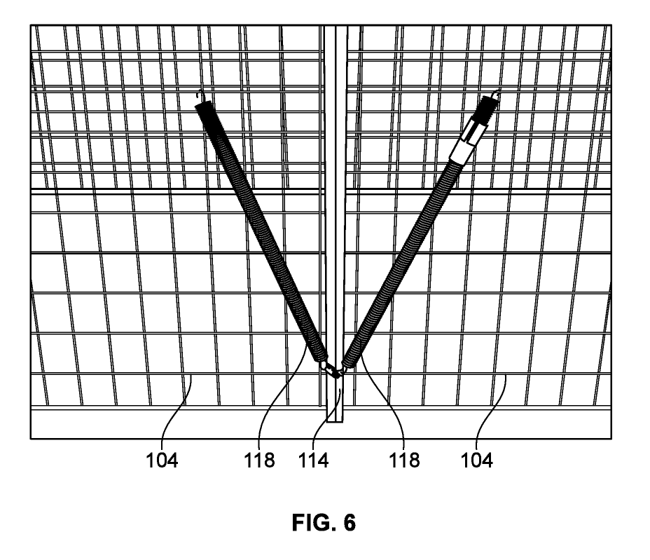

FIG. 6 illustrates an opposing pair of flexible and extendable connectors 118 which may be a pair of springs to connect the array of wire 104 of the trap 100 to the ground anchor 116.

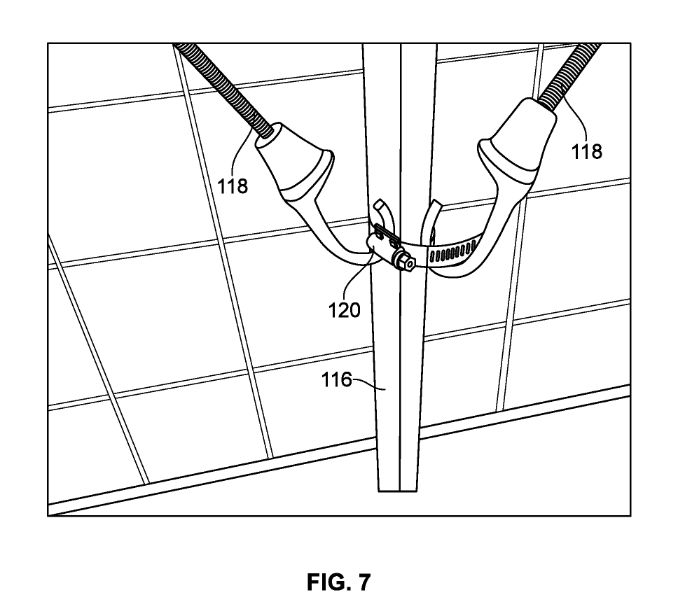

FIG. 7 illustrates a portion of the trap 100 and the opposing pair (only one end showing) of flexible and extendable connectors 118 which may be a pair of bungee cords (tie down cords) to connect the trap 100 to the ground anchor 116 (by a suitable connector 120). The flexible and extendable connector 118 may connect to the trap 100 and may connect to the ground anchor 116.

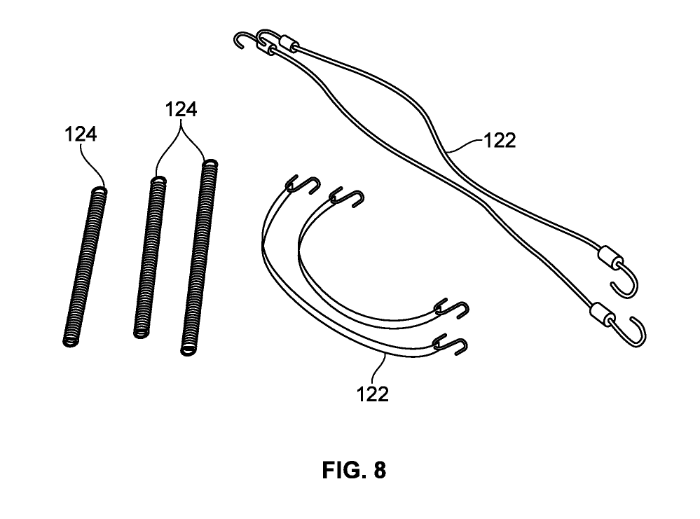

FIG. 8 illustrates a first pair of bungee cords 122 which may be longer than a second pair of bungee cords 122 and illustrates a first spring 124 which may be longer than a second spring 124 which may be longer than third spring 124.

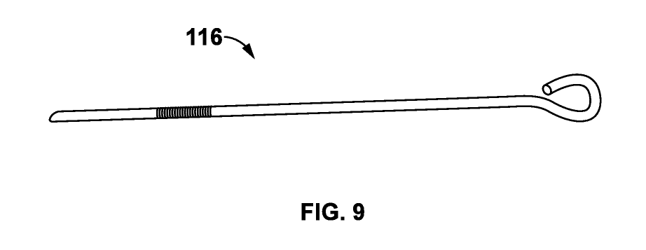

FIG. 9 illustrates a ground anchor 116 of the present invention and more particularly a ground anchor 116 having a spiral screw at one end and a eye loop at the other end.

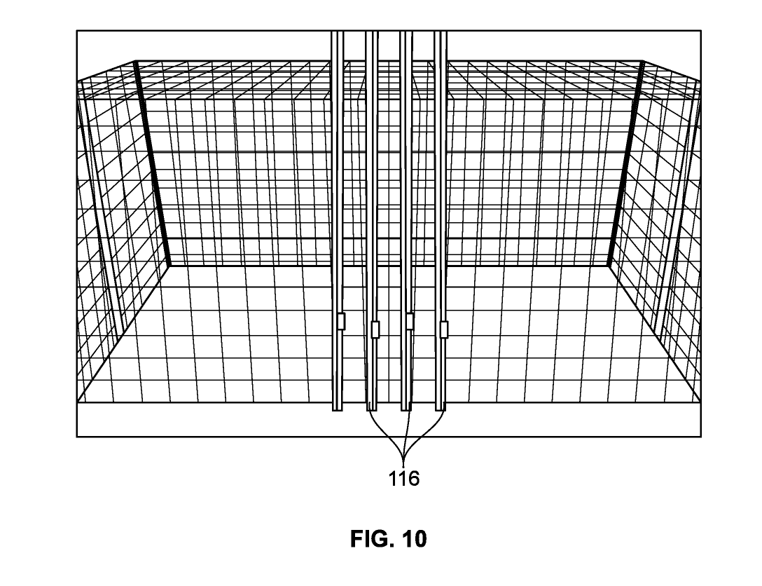

FIG. 10 illustrates a multitude of ground anchors 116 of the present invention and illustrates a stake having a stability plate at one end.

Other types of ground anchors may be used with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) An animal trap for holding animals:
the trap having an open bottom to allow access to the ground or support surface;
the trap having a frame to support a wire grid;
a ground anchor to be positioned in the ground or support surface;
a flexible and extending connector to connect the frame with the ground anchor.

2) An animal trap for holding animals as in claim 1, wherein the frame includes a bottom frame member.

3) An animal trap for holding animals as in claim 1, wherein the frame includes a top frame member.

4) An animal trap for holding animals as in claim 1, wherein the frame includes a vertical frame member.

5) An animal trap for holding animals as in claim 1, wherein the flexible and extending connector includes a bungee cord.

6) An animal trap for holding animals as in claim 1, wherein the flexible and extending connector includes a spring.
